(19) United States
(12) Patent Application Publication
(10) Pub. No.: US 2018/0346370 A1
(43) Pub. Date: Dec. 6, 2018

(54) Sealing Glass Composition

(71) Applicant: NIHON YAMAMURA GLASS CO., LTD., Amagasaki-shi (JP)

(72) Inventor: Naoto Kobayashi, Amagasaki-shi (JP)

(73) Assignee: NIHON YAMAMURA GLASS CO., LTD., Amagasaki-shi (JP)

(21) Appl. No.: 15/778,019

(22) PCT Filed: Nov. 25, 2016
(86) PCT No.: PCT/JP2016/084993

§ 371 Date: May 22, 2018

(30) Foreign Application Priority Data
Nov. 27, 2015 (JP) 2015-231868

(51) Int. Cl. C03C 3/087; C03B 32/02; C03C 8/04; C03C 3/062

(52) U.S. Cl. CPC C03C 3/087; C03B 32/02; H01C 7/008; C03C 3/062; C03C 8/04

(57) ABSTRACT

To provide a sealing glass composition capable of forming a sealing material, which has properties suitable for sealing electronic components and which is able to withstand higher temperature ranges. Provided is a glass composition for producing a glass ceramic sealant containing at least CaO—ZnO—SiO₂-based crystals, this sealing glass composition containing at least following components: 1) 35 to 55 mol. % of SiO₂, 2) 15 to 45 mol. % of CaO, 3) 1 to 25 mol. % of ZnO, 4) 0 to 25 mol. % of Al₂O₃, and 5) a total of 0 to 20 mol. % of RO where R represents at least one of Mg, Sr and Ba.

### TECHNICAL FIELD

The present invention relates to a sealing glass composition that can be used for sealing electronic components and the like.

### BACKGROUND ART

Electronic components that include semiconductors and the like are sealed or enclosed by means of a variety of glasses, resins, and the like, in order to protect the electronic components from external environments. Thermistors are an example of such electronic components. Thermistors are used as temperature sensors by utilizing the characteristic that the electrical resistance of a semiconductor varies greatly with changes in temperature. When used in high temperature atmospheres and oxidizing atmospheres in particular, thermistors are coated and sealed with glasses and the like in order to prevent degradation in such environments. FIG. 1 shows the basic configuration of a bead type thermistor (a lead type), which is a typical example of a thermistor. In this thermistor 10, two lead wires 13 are connected by means of a semiconductor element 12, and a sealing material layer 11 is provided so as to coat and seal the semiconductor element 12 and the lead wires 13. In the past, glasses, resins, and the like, were used as sealants that constitute this sealing material layer 11, but glasses in particular were frequently used from the perspective of excellent heat resistance and the like.

In cases where a glass is used as a sealing material, in addition to the need to exhibit high electrical resistance, it is necessary for the sealing material to have a coefficient of thermal expansion that is the same as, or similar to, the coefficients of thermal expansion of the semiconductor element and lead wires so that cracks and gaps do not occur when the semiconductor element and lead wires are coated and sealed.

Borosilicate glasses have been proposed as examples of sealing materials for this type of temperature sensor (see Patent Documents 1 and 2). In addition, crystallized glasses are used as sealing materials for temperature sensors used at higher temperatures. For example, crystallized glasses in which lanthanoid titanate crystals or diopside crystals are precipitated are known (see Patent Document 3).

### CITATION LIST

### Patent Document

[Patent Document 1] Japanese Patent Application Publication No. 2002-037641
[Patent Document 2] WO 2006/035882
[Patent Document 3] Japanese Patent Application Publication No. 2008-120648

### SUMMARY OF INVENTION

### Technical Problem

Higher heat resistance is required in cases where a glass is used as a sealing material for an electronic component. That is, a reliable sealing effect needs to be achieved, without the sealing material undergoing softening and deformation, even when the electronic component is exposed to high temperatures. It can be said that such requirements are more important in the case of temperature sensors (thermistors) and the like.

Power generation devices can be given as an example of devices in which temperature sensors are used. In recent years, consideration has been given to environmental problems such as increased carbon dioxide emissions and acid rain, and combustion systems in power generation devices need to be maintained at optimal operating conditions in order to minimize the generation of harmful gases such as CO₂ and NOₓ. In order to optimize combustion conditions in such combustion systems, the temperature in such combustion systems must be controlled by means of a temperature control system that includes temperature sensors and the like. Moreover, temperature regions to be controlled must also cover higher temperature regions.

However, it cannot be said that conventional temperature sensors are satisfactory in terms of the heat resistance of glasses that are sealing materials. In addition, temperature sensors in which crystallized glasses are used as sealing materials do not soften and deform in relatively high temperature regions, but because it is difficult to maintain a stable state in higher temperature regions (for example, 1,100° C. or higher), concerns remain from practical perspectives.

Therefore, the main purpose of the present invention is to provide a glass composition capable of forming a sealing material, which has physical properties suitable for sealing electronic components and which is resistant to higher temperature heat.

### Solution to Problem

As a result of diligent research relating to problems inherent in the prior art, the inventor of the present invention found that the purpose mentioned was achieved by means of a glass composition having a specific compositional make up, and thereby completed the present invention.

That is, the present invention relates to the sealing glass compositions and sealing materials described below.

1. A sealing glass composition for producing a crystallized glass sealing material containing at least CaO—ZnO—SiO₂-based crystals, this sealing glass composition containing at least following components:

1) 35 to 55 mol. % of SiO₂,

2) 15 to 45 mol. % of CaO,

3) 1 to 25 mol. % of ZnO,

4) 0 to 25 mol. % of Al₂O₃, and

5) a total of 0 to 20 mol. % of RO (where R represents at least one of Mg, Sr and Ba).

2. The sealing glass composition according to 1 above, in which the components mentioned above are contained at following quantities:

1) 41 to 55 mol. % of SiO₂,

2) 20 to 39 mol. % of CaO,

3) 3 to 19 mol. % of ZnO,

4) 0.1 to 21 mol. % of Al₂O₃, and

5) a total of 0 to 20 mol. % of RO (where R represents at least one of Mg, Sr and Ba).

3. The sealing glass composition according to 1 above, in which the components mentioned above are contained at following quantities:

1) 42 to 52 mol. % of SiO₂,

2) 29 to 36 mol. % of CaO,

3) 5 to 16 mol. % of ZnO,

4) 2 to 19 mol. % of Al₂O₃, and

5) a total of 0 to 20 mol. % of RO (where R represents at least one of Mg, Sr and Ba).

4. The sealing glass composition according to 1 above, containing 0 to 5 mol. % of MgO, 0 to 20 mol. % of SrO and 0 to 5 mol. % of BaO as the RO component.
5. The sealing glass composition according to 1 above, further containing 1 to 9 mol. % of B₂O₃.
6. A CaO—ZnO—SiO₂-based crystallized glass sealing agent,
(1) containing at least following components:

1) 35 to 55 mol. % of SiO₂,

2) 15 to 45 mol. % of CaO,

3) 1 to 25 mol. % of ZnO,

4) 0 to 25 mol. % of Al₂O₃, and

5) a total of 0 to 20 mol. % of RO (where R represents at least one of Mg, Sr and Ba), and

(2) containing at least Ca₂ZnSi₂O₇ crystals as CaO—ZnO—SiO₂-based crystals.
7. The CaO—ZnO—SiO₂-based crystallized glass sealing agent according to 6 above, further containing 1 to 9 mol. % of B₂O₃.
8. The CaO—ZnO—SiO₂-based crystallized glass sealing agent according to 6 above, wherein the coefficient of thermal expansion within a temperature of 50° C. to 850° C. is 50 to 95×10⁻⁷/° C.
9. An electronic device comprising an electronic component enclosed with the CaO—ZnO—SiO₂-based crystallized glass sealing agent according to 6 above.
10. A method for producing a CaO—ZnO—SiO₂-based crystallized glass sealing agent, the method including a step for heat treating the sealing glass composition according to 1 above at a temperature of 1000° C. to 1300° C.

### Advantages of Invention

According to the sealing glass composition of the present invention (the glass composition of the present invention), it is possible to form a sealing agent which has properties suitable for sealing electronic components and which is resistant to higher temperature heat. That is, the sealant of the present invention can be advantageously provided by the glass composition of the present invention.

The glass composition of the present invention is fired at the time of use, but because a glass ceramic (the sealant of the present invention) containing CaO—ZnO—SiO₂-based crystals (and especially Ca₂ZnSi₂O₇ crystals) is formed by the firing, it is possible to exhibit excellent heat resistance within a temperature range from approximately 1,100° C. to lower than the melting point of the crystals (approximately 1350° C.) Moreover, this glass ceramic has a coefficient of thermal expansion that is similar to that of an electronic component (for example, a metal and/or a semiconductor), and can therefore effectively inhibit or prevent degradation, deformation, and the like, even when exposed to high temperature conditions for long periods of time and causes no concerns regarding a reduction in viscosity, and can therefore be advantageously used as a sealing material under high temperature conditions.

In addition, because the glass composition of the present invention exhibits high fluidity even in a sealing step (during firing) that uses the glass composition of the present invention, wettability, adhesion and followability to an electronic component are excellent, and it is possible to achieve effective sealing with no voids or pores (especially when coating and sealing an electronic component by directly coating with the sealant of the present invention). In addition, these characteristics can contribute to increased efficiency in a sealing step (and even in production of an electronic device).

For example, the glass composition and sealant of the present invention, which exhibit such characteristics, can be advantageously used for sealing in order to protect electronic components (semiconductor elements and the like) from external environments.

### BRIEF DESCRIPTION OF DRAWINGS

FIG. 1 is a schematic diagram showing the configuration of an ordinary bead type thermistor.

FIG. 2 is a graph showing the results of X-Ray diffraction analysis of a sintered body of the glass composition obtained in Example 1.

### REFERENCE SIGNS LIST

10 Thermistor
11 Sealant layer
12 Semiconductor element
13 Lead wire

### DESCRIPTION OF EMBODIMENTS

### 1. Sealing Glass Composition

### (1) Sealing Glass Composition

The sealing glass composition of the present invention (the glass composition of the present invention) is a glass composition that is used to produce CaO—ZnO—SiO₂-based glass ceramics, and is characterized by containing at least following components:

1) 35 to 55 mol. % of SiO₂,

2) 15 to 45 mol. % of CaO,

3) 1 to 25 mol. % of ZnO,

4) 0 to 25 mol. % of Al₂O₃, and

5) a total of 0 to 20 mol. % of RO (where R represents at least one of Mg, Sr and Ba). The components of the sealing glass composition of the present invention will now be explained.

SiO₂

In the glass composition of the present invention, SiO₂ is a glass network-forming component, and is a component that is effective mainly for improving the stability of the glass when the glass is produced and for producing CaO—ZnO—SiO₂-based crystals when the glass composition of the present invention is used (that is, in a fired body of the glass composition of the present invention).

The content of SiO₂ in the glass composition of the present invention is generally 35 to 55 mol. %, preferably 41 to 55 mol. %, more preferably 42 to 52 mol. %, and most preferably 45 to 50 mol. %. In cases where the content of SiO₂ is less than 35 mol. %, crystals precipitate in the glass in some cases. If crystals precipitate in the glass, in a glass powder obtained by pulverizing the glass, the crystallization starts fast when the glass powder is fired. As a result, fluidity decreases in the initial stage following the start of firing, which leads to concerns that voids will be formed between a sealed object after firing and the obtained glass ceramic, and the desired sealing cannot be achieved. Moreover, sufficient CaO—ZnO—SiO₂-based crystals may not be formed when glass powder is fired. Meanwhile, if the content of SiO₂ exceeds 55 mol. %, a glass may not be formed, and even if a glass is formed, there are concerns that the coefficient of thermal expansion will increase because of abnormal expansion caused by precipitation of SiO₂ crystals following firing.

CaO

In the glass composition of the present invention, CaO is a component that is effective mainly for precipitating CaO—ZnO—SiO₂-based crystals (and especially Ca₂ZnSi₂O₇ crystals) in a glass ceramic obtained by sintering the glass composition of the present invention.

The content of CaO in the glass composition of the present invention is generally 15 to 45 mol. %, preferably 20 to 39 mol. %, more preferably 29 to 36 mol. %, and most preferably 31 to 34 mol. %. In cases where the content of CaO is less than 15 mol. %, the desired crystals are not sufficiently precipitated in the crystallized glass after sintering, and the residual proportion of glass phases (amorphous phases) relative to crystal phases increases. As a result, there are concerns that it is not possible to impart the crystallized glass having good heat resistance. In cases where the content of CaO exceeds 45 mol. %, crystals precipitate in the glass and fluidity is insufficient when the glass composition of the present invention is sintered, meaning that there are concerns that the desired sealing cannot be obtained.

ZnO

In the glass composition of the present invention, ZnO is a component that is essential mainly for producing CaO—ZnO—SiO₂-based crystals.

The content of ZnO in the glass composition of the present invention is generally 1 to 25 mol. %, preferably 3 to 19 mol. %, more preferably 5 to 16 mol. %, further preferably 10 to 15 mol. %, and most preferably 13 to 15 mol. %. In cases where the content of ZnO is less than 1 mol. %, there are concerns that the crystallinity will be insufficient in glass ceramics obtained by firing the glass composition of the present invention. In addition, in cases where the content of ZnO exceeds 25 mol. %, a glass may not be formed, and even if a glass is formed, there are concerns that the crystallization temperature will be too low and that the fluidity will decrease when the glass composition of the present invention is fired.

Al₂O₃

In the glass composition of the present invention Al₂O₃ is an optional component that is used mainly for improving stability and adjusting the crystallization initiation temperature when a glass is produced. In addition, Al₂O₃ is a component that is useful for forming CaO—Al₂O₃—SiO₂-based crystals (and especially CaAl₂Si₂O₈ crystals), which contribute to an improvement in heat resistance of a glass ceramic.

The content of Al₂O₃ in the glass composition of the present invention is generally 0 to 25 mol. %, preferably 0.1 to 21 mol. %, more preferably 2 to 19 mol. %, and most preferably 3 to 12 mol. %. If the content of Al₂O₃ exceeds 25 mol. %, the difference between glass softening temperature and crystallization initiation temperature may become too small. As a result, sealability by the glass composition may decreases.

RO

In the glass composition of the present invention, RO (here, R represents at least one of Mg, Sr and Ba) is an optional component that is effective for lowering the melting temperature when producing a glass and facilitating production of the glass, and is also effective as a component for lowering the softening point.

The total content of RO in the glass composition of the present invention is generally 0 to 20 mol. %, preferably 0 to 10 mol. %, and more preferably 0.1 to 5 mol. %. In cases where the content of RO exceeds 20 mol. %, the softening point of the glass is excessively lowered, which leads to concerns regarding a deterioration in heat resistance. Explanations will now be given of the functions and preferred content values of MgO, SrO and BaO.

MgO is an optional component that is effective mainly for lowering the melting temperature when producing a glass and facilitating production of the glass, and is also a component that lowers the softening point of the glass.

The content of MgO in the glass composition of the present invention preferably falls within the range 5 mol. % or less. In cases where the content of MgO exceeds 5 mol. %, a glass may not be formed, and there are concerns that the crystallization temperature of glass ceramics obtained using the glass composition of the present invention will become too low. In addition, MgO—CaO—SiO₂-based crystals, which melt at a relatively low temperature, tend to precipitate in glass ceramics obtained using the glass composition of the present invention, and there are concerns that heat resistance of a crystallized glass will deteriorate in high temperature regions. In addition, there are concerns that the coefficient of thermal expansion of a crystallized glass will become too high. In view of the softening point and fluidity of an obtained glass and the coefficient of thermal expansion of a glass ceramic, the content of MgO is more preferably 1 mol. % or less, and it is most preferable for MgO to be essentially not present.

Moreover, in the present invention, “essentially not present” does not mean that a case in which a component is contained at an impurity level is excluded, and it is acceptable for the component to be present at a level contained as a mere impurity in a raw material or the like used to produce a glass. More specifically, the cases where the total weight expressed as oxide content of these components is 1000 ppm or less fall into the category of “essentially not present” because such small quantity of these components do little harm to the sealing glass composition of the present invention.

BaO is a component that has the main functions of 1) lowering the softening point, 2) lowering the melting temperature when producing a glass, and 3) increasing the coefficient of thermal expansion.

It is generally preferable for the content of BaO in the glass composition of the present invention to fall within the range 0 to 17 mol. %. In cases where the content of BaO exceeds 17 mol. %, there are concerns that the crystallization temperature will be too low even if a glass is produced. Further, because BaO—ZnO—SiO₂-based crystals, which have a relatively high coefficient of thermal expansion, are readily precipitated in glass ceramics obtained using the glass composition of the present invention, there are concerns that the coefficient of thermal expansion of the glass ceramics will become too high. In view of the softening point, fluidity, and the like, of an obtained glass, the content of BaO is preferably 0 to 5 mol. %, and more preferably 0 to 1 mol. %.

SrO is an optional component that is effective mainly for lowering the melting temperature when producing a glass and facilitating production of the glass, and is also a component that lowers the softening point of the glass.

It is generally preferable for the content of SrO in the glass composition of the present invention to fall within the range 0 to 20 mol. %. In cases where the content of SrO in the glass composition of the present invention exceeds 20 mol. %, the crystallization temperature will be too low even if a glass is obtained. In view of the softening point, fluidity, and the like, of an obtained glass, the content of SrO is more preferably 0 to 5 mol. %, and further preferably 0 to 1 mol. %. Accordingly, a composition in which SrO is essentially not present can be advantageously employed as the glass composition of the present invention.

### Other Components

### a) Alkali Metals

Because alkali metals such as Na and K lead to concerns that reactions with surrounding members will be accelerated in high temperature regions in particular, it is preferable for alkali metals to be essentially not present in the glass composition of the present invention.

### b) Boron

B₂O₃ readily stabilizes the state of a glass in a glass production process, but leads to concerns regarding volatilization while a glass is heated at a high temperature, thereby contaminating surrounding members. Therefore, it is preferable for B₂O₃ to be essentially not present in the sealing glass composition of the present invention. On the other hand, it is preferable to add B₂O₃ in order to stabilize the state of the glass. By adding B₂O₃, it is possible to increase the difference ΔT (=Tx−Ts) between the crystallization initiation temperature (Tx) of a glass and the softening point (Ts) of the glass, thereby enabling an improvement in sealability, flow properties, and the like. From the view point of the above, the content of added B₂O₃ can generally be set within the range of less than 10 mol. %, and is preferably approximately 1 to 9 mol. %, and more preferably 2.5 to 6.5 mol. %.

### c) Neutral Components

As long as the relationships mentioned above between the content values of SiO₂, Al₂O₃, ZnO and CaO in the glass composition of the present invention are satisfied, neutral components that do not greatly affect properties of the glass composition and glass ceramics of the present invention may be added at quantities that do not substantially adversely affect the advantages of the present invention. Examples of these neutral components include at least one type selected from among Y₂O₃, La₂O₃, TiO₂, ZrO₂ and CeO₂. The content values of these components can generally be set as appropriate within a range whereby the total quantity of SiO₂, CaO, ZnO, Al₂O₃ and RO is 95 mol. % or more. In addition, in cases where a relatively large quantity of an optional component such as B₂O₃ is added, the content of neutral components can be set as appropriate within a range whereby the total quantity of SiO₂, CaO, ZnO, Al₂O₃ and RO is 85 mol. % or more.

The content ranges of the components can be adjusted as mentioned above in the glass composition of the present invention. Therefore, a glass composition containing, for example, 1) 42 to 47 mol. % of SiO₂, 2) 30 to 34 mol. % of CaO, 3) 11 to 15 mol. % of ZnO, 4) 5 to 9 mol. % of Al₂O₃ and 5) 0.5 to 2 mol. % of RO can be advantageously used. In addition, a glass composition containing, for example, 1) 42 to 47 mol. % of SiO₂, 2) 30 to 34 mol. % of CaO, 3) 11 to 15 mol. % of ZnO, 4) 5 to 9 mol. % of Al₂O₃, 5) 0.5 to 2 mol. % of RO and 6) 2 to 6 mol. % of B₂O₃ can be advantageously employed.

### (2) Form or the Like of Sealing Glass Composition

The form of the glass composition of the present invention is not limited, but a powdered form is generally preferable. In such cases, the particle diameter is not particularly limited, but it is preferable for the average particle diameter to be 2 to 10 μm and for the maximum particle diameter to be 150 μm or less (and especially 110 μm or less). In particular, in cases where an electronic component is coated and sealed using the glass composition of the present invention, it is necessary to wet the surface of the object being treated (an electronic component) while the glass powder temporarily contracts, softens and fluidizes during sintering, but by controlling the particle diameter, it is possible to achieve higher fluidity during firing.

That is, in the case of a fine glass powder whose particle diameter is too small, crystallization initiation occurs earlier, and fluidity during sealing by firing decreases. As a result, the flow of the powder may be impaired and production costs for a product produced using this sealing material will be higher due to the need to increase the number of times that the sealing material is applied and fired. Meanwhile, in the case of a coarse glass powder having an excessively large particle diameter, the problem of sedimentation and separation of powder particles occurs when forming a paste from the powder or when applying and drying the powder. In addition, there are concerns that crystallization will be non-uniform or insufficient and that the strength of a sintered body will be inadequate. Therefore, it is preferable to adjust the particle diameter by removing fine powder and coarse powder (and especially coarse powder) by carrying out a procedure such as classification. Therefore, it is preferable to adjust the particle size of a powder in the glass composition of the present invention so as to have an average particle diameter of 2 to 10 μm and a maximum particle diameter of 150 μm or less (and especially 110 μm or less).

The glass transition point (Tg) of the glass composition of the present invention is not limited, but may generally fall within the range 600° C. to 800° C. Accordingly, a temperature range of, for example, 650° C. to 720° C. can be used.

The softening point (Ts) of the glass composition of the present invention is not limited, but should generally fall within the range 700° C. to 900° C. Therefore, a temperature range of, for example, 780° C. to 840° C. can be used.

The crystallization initiation temperature (Tx) of the glass composition of the present invention is not limited, but may generally fall within the range 800° C. to 1100° C. Therefore, a temperature range of, for example, 950° C. to 990° C. can be used.

From perspectives such as flow properties and sealability of a glass, the difference ΔT between the crystallization initiation temperature (Tx) and the softening point (Ts) in the glass composition of the present invention is preferably large. More specifically, the value of ΔT is preferably 70° C. or higher, and more preferably 100° C. or higher. By regulating to a larger ΔT value in this range, it is possible to ensure a sufficient period of time until the glass crystallizes, thereby more reliably ensuring good flow properties and high sealability. In this case, the upper limit for ΔT is not limited, but can be set to approximately 200° C., for example.

### (3) Method for Producing Sealing Glass Composition

The actual method for producing the glass composition of the present invention is not particularly limited, and the glass composition can be produced using a production method that includes, for example, 1) a step for mixing raw materials that are formulated so as to obtain the compositional make up of the glass composition of the present invention (a mixing step), 2) a step for preparing a molten glass by melting the obtained mixture at a temperature of 1400° C. to 1600° C. (a melting step) and 3) a step for cooling the molten glass in such a way that crystallization does not occur (a cooling step).

In terms of raw materials, compounds serving as sources of the glass components can be used. In general, oxides of elements contained in the glass composition of the present invention (Si, Ca, Al, Zn, and the like) may be used as starting materials, but it is also possible to use hydroxides, carbonates, nitrates, and the like. That is, it is possible to use, as appropriate, Si in the form of SiO₂ or the like, Ca in the form of CaO, CaCO₃, or the like, Al in the form of Al₂O₃, Al(OH)₃, or the like, and Zn in the form of ZnO or the like. These raw materials can generally be used in the form of powders, and it is possible to prepare a mixed powder by uniformly mixing these powders.

A molten glass is prepared by melting a mixture (mixed powder) obtained in this way, generally at a temperature of 1400° C. to 1600° C. The melting atmosphere is not limited, but the melting step can generally be carried out at atmospheric pressure in air (or in an oxidizing atmosphere).

Next, the molten glass is cooled in a cooling step in such a way as not to cause crystallization. Such cooling conditions may be similar to those used when producing publicly known glasses, and it is possible to use a method comprising bringing a molten glass into contact with a stainless steel cooling roller so as to rapidly cool the molten glass, for instance.

The glass composition of the present invention can be obtained in this way, but a publicly known treatment such as pulverization or classification may be carried out if necessary. Moreover, in cases where the particle size is adjusted by means of pulverization, classification, or the like, it is preferable to adjust the particle size so as to have an average particle diameter of 2 to 10 μm and a maximum particle diameter of 150 μm or less (and especially 110 μm or less).

### (3) Use of Sealing Glass Composition

The glass composition of the present invention can be used in the form of, for example, a powder (a dry powder), but it is also possible to use the glass composition of the present invention in the form of a liquid composition such as a slurry or paste obtained by dispersing the powdered glass composition of the present invention in a binder and/or a solvent.

In cases where the glass composition of the present invention is used as a liquid composition, the composition may be prepared by mixing at least one type of solvent and organic binder. For example, a liquid composition can be advantageously prepared by mixing the powdered glass composition of the present invention with at least one type of solvent and organic binder. In cases where a liquid composition is prepared, the average particle diameter of the glass composition powder of the present invention is not particularly limited, but it is generally preferable for this average particle diameter to be 2 to 10 μm, and especially 5 to 10 μm. In addition, the powder preferably has a maximum particle diameter of 150 μm or less, and especially 110 μm or less.

The organic binder is not particularly limited, and a binder selected from among publicly known binders can be used as appropriate according to the specific intended use of the glass composition of the present invention (the article to be sealed, and the like). For example, the organic binder can be a cellulose resin such as ethyl cellulose, but is not limited thereto.

A solvent selected from among publicly known organic solvents can be selected as appropriate as the solvent according to the type of binder being used. For example, the solvent can be an alcohol such as ethanol or isopropanol, or an organic solvent such as a terpineol (α-terpineol or a mixture of α-terpineol, β-terpineol and γ-terpineol, with the α-terpineol being contained as the main component), but is not limited thereto. Moreover, it is possible to use a single organic solvent in isolation or a combination of two or more types thereof.

In addition, when preparing the liquid composition in the present invention, publicly known additives, such as plasticizers, thickening agents, sensitizers, surfactants, dispersing agents and coloring agents, may be blended as appropriate if necessary.

In the present invention, an electronic component can be sealed using the glass composition of the present invention. The sealing method per se can be carried out in accordance with publicly known sealing methods. For example, it is possible to use a method that comprises a step for directly coating the glass composition of the present invention so as to be in contact with a surface of an object to be sealed, such as an electronic component, and a step for sintering the glass composition of the present invention disposed on the surface, or a method that comprises a step for disposing the glass composition of the present invention between a container that houses an electronic component and a lid of the container and a step for sintering the thus disposed glass composition of the present invention.

In such cases, when coating or the like is carried out using the glass composition of the present invention, a method in which the composition is disposed in the form of a powder in required locations or a method in which the liquid composition is coated by means of a publicly known method (rolling, spraying, or the like) may be used. In addition, it is also possible to use a method in which the glass composition of the present invention is formed into a prescribed molded body in advance and the molded body is then disposed in a required location.

### 2. CaO—ZnO—SiO₂-Based Glass Ceramic Agent

The present invention encompasses a CaO—ZnO—SiO₂-based glass ceramic sealant (the sealant of the present invention), which is characterized by

(1) containing at least following components:

1) 35 to 55 mol. % of SiO₂,

2) 15 to 45 mol. % of CaO,

3) 1 to 25 mol. % of ZnO,

4) 0 to 25 mol. % of Al₂O₃, and

5) a total of 0 to 20 mol. % of RO (where R represents at least one of Mg, Sr and Ba), and

(2) containing at least Ca₂ZnSi₂O₇ crystals as CaO—ZnO—SiO₂-based crystals.

The sealant of the present invention is constituted essentially from a CaO—ZnO—SiO₂-based crystallized glass. CaO—ZnO—SiO₂-based crystals are not limited to those containing Ca₂ZnSi₂O₇ crystals, and may include other crystal phases (that is, substitutional solid solutions and interstitial solid solutions of Ca₂ZnSi₂O₇ crystals). In addition, crystal phases other than CaO—ZnO—SiO₂-based crystals may be included as long as they do not substantially adversely affect the advantages of the present invention. Examples of such crystals include CaO—Al₂O₃—SiO₂-based crystals (for example, CaAl₂Si₂O₈ crystals) and CaO—SiO₂-based crystals.

The sealant of the present invention is obtained by using, for example, the glass composition of the present invention as a starting material. In cases where the glass composition of the present invention is used as the starting material, the sealant of the present invention can be obtained by sintering the glass composition of the present invention.

Sintering conditions are generally not particularly limited as long as at least Ca₂ZnSi₂O₇-based crystals are formed. The sintering temperature can generally be approximately 1000° C. to 1300° C. In addition, the sintering atmosphere can generally be air or an oxidizing atmosphere. In addition, the sintering pressure can be atmospheric pressure.

The sealant of the present invention has a similar composition to the glass composition of the present invention, and the preferable composition is similar to that of the glass composition of the present invention. Accordingly, for example, a glass composition containing 1) 42 to 47 mol. % of SiO₂, 2) 30 to 34 mol. % of CaO, 3) 11 to 15 mol. % of ZnO, 4) 5 to 9 mol. % of Al₂O₃ and 5) 0.5 to 2 mol. % of RO can be advantageously used. In addition, a glass composition containing 1) 42 to 47 mol. % of SiO₂, 2) 30 to 34 mol. % of CaO, 3) 11 to 15 mol. % of ZnO, 4) 5 to 9 mol. % of Al₂O₃, 5) 0.5 to 2 mol. % of RO and 6) 2 to 6 mol. % of B₂O₃ can be advantageously employed for example.

The coefficient of thermal expansion (a value) of the sealant of the present invention is not particularly limited, but the coefficient of thermal expansion within the temperature range 50° C. to 850° C. is 50 to 95×10⁻⁷/° C., preferably 60 to 90×10⁻⁷/° C., and more preferably 70 to 85×10⁻⁷/° C. If the coefficient of thermal expansion is regulated within such a range, it is possible to further improve the sealability of an electronic component.

### EMBODIMENTS

Shown below are embodiments for cases in which a semiconductor element is sealed using the sealant of the present invention using the glass composition of the present invention as the starting material.

A variety of modes can be employed as sealing steps. For example, it is possible to use (1) a method that comprises a) a step for forming a precursor layer by coating a part or all of an electronic component with the glass composition of the present invention so as to be in contact with the surface of the electronic component and b) a step for firing the precursor layer so as to form a sealing material layer that contains a crystallized glass (a coating sealing method) or (2) a method that comprises a) a step for forming a precursor layer comprising the glass composition of the present invention in a contact region between a container in which an electronic component is housed and a lid for the container, b) a step for covering the container with the lid and c) a step for sintering the precursor layer so as to form a sealing material layer that contains a crystallized glass (a bonding sealing method).

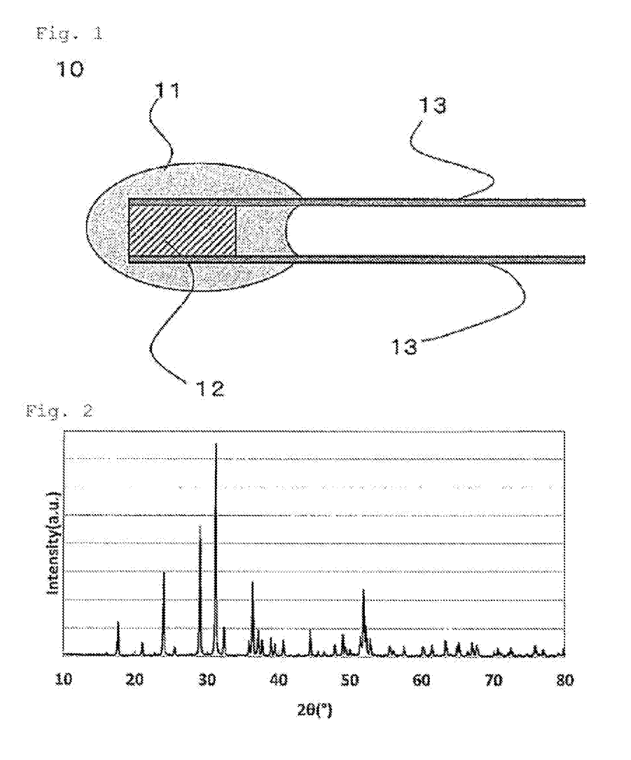

In particular, a coating sealing method can be used advantageously for the glass composition of the present invention from perspectives such as achieving good fluidity and an appropriate coefficient of thermal expansion. As shown in FIG. 1, in cases where a thermistor 10 is produced as an electronic device, a semiconductor element 12 to which two lead wires 13 are connected is prepared as an electronic component, and the electronic component can then be advantageously coated and sealed by means of a method that includes a) a step for forming a precursor layer by directly coating the whole of the semiconductor element 12 and a part of the two lead wires 13 with the glass composition of the present invention and b) a step for sintering the precursor layer so as to form a sealant layer 11 that contains a glass ceramics. By carrying out a coating sealing treatment in this way, at least the entire electronic component of the electronic device is embedded in the CaO—ZnO—SiO₂-based crystallized glass sealing agent (hereinafter referred to as the sealant of the present invention), thereby effectively protecting the electronic component from external environments.

Moreover, in cases where an electronic component is sealed using the glass composition of the present invention, the firing temperature and the like may be in accordance with the firing conditions disclosed in “2. CaO—ZnO—SiO₂-based glass ceramic sealant” above.

### EXAMPLES

The technical features of the present invention will now be explained in greater detail through the use of Examples and Comparative Examples. However, the scope of the present invention is not limited to Examples.

### Examples 1 to 27 and Comparative Examples 1 to 4

Glass flakes were obtained by formulating and mixing raw materials according to the glass compositions shown in Tables 1 to 8, placing the formulated raw materials in a platinum crucible, melting the raw materials over a period of 2 hours at a temperature of 1450° C. to 1600° C., and then bringing the molten glass into contact with a cooling roller made of a stainless steel so as to rapidly cool the molten glass. The glass flakes were placed in a pot mill and pulverized while adjusting the average particle diameter to approximately 5 to 10 μm. The glass powders of Examples and Comparative Examples were then obtained by removing coarse particles by means of a sieve having an opening size of 106 μm.

Moreover, SiO₂, Al(OH)₃, CaCO₃, SrCO₃, Mg(OH)₂, BaCO₃ and ZnO were used as the starting materials mentioned above (the sources for the components) used to produce the glass compositions of Examples and Comparative Examples.

### Test Example 1

Using the methods described below, the glass powders of Examples and Comparative Examples were measured in terms of glass transition point, softening point, crystallization initiation temperature and average particle diameter. In addition, green compacts obtained by firing the glass powders in air were measured and evaluated in terms of flow diameters and coefficient of thermal expansion. These results are shown in Tables 1 to 8. Moreover, methods used to measure the various properties are as described below.

(1) Glass Transition Point, Softening Point and Crystallization Initiation Temperature

Glass transition point (Tg), softening point (Ts) and crystallization initiation temperature (Tx) were measured by filling a platinum cell with approximately 40 mg of glass powder and increasing the temperature from room temperature at a rate of 20° C./min using a DTA measurement apparatus (Thermo Plus TG8120 available from Rigaku Corporation).

(2) Particle Size of Glass Powder (Average Particle Diameter)

The volume distribution mode D50 value was determined using a laser scattering type particle size distribution analyzer.

(3) Sealability

A cylindrical compacted powder body having a diameter of 20 mm and a height of 10 to 15 mm was formed using 5 g of glass powder. This molded body was placed on an alumina substrate and fired for 1 hour at 1100° C., and the appearance of the obtained fired body was evaluated. Evaluation criteria were such that cases in which the corners of the fired body were removed and the fired body flowed were evaluated as “0”, cases in which corners of the fired body remained but the fired body had shrunk were evaluated as “A” and cases in which the fired body did not shrink or the fired body melted were evaluated as “X”.

(4) Coefficient of Thermal Expansion

A test sample was prepared by cutting the fired body obtained in the above section (3) to a size of approximately 5 mm×5 mm×15 mm. The coefficient of thermal expansion α (×10⁻⁷/° C.) of the test sample was determined from two points at 50° C. and 850° C. on a thermal expansion curve obtained when heating the test sample from room temperature at a rate of 10° C./min using a TMA measurement apparatus.

(5) Crystal Form

The fired body obtained in the above section (3) was subjected to powder X-Ray diffraction analysis. Results for Example 1 are shown in FIG. 2. As shown in FIG. 2, the presence of Ca₂ZnSi₂O₇ crystal phases was confirmed. The presence of Ca₂ZnSi₂O₇ crystal phases was also confirmed in other Examples.

TABLE 1

| Composition (mol. %) | | Example 1 | Example 2 | Example 3 | Example 4 | Example 5 | Example 6 |
|---|---|---|---|---|---|---|---|
| SiO₂ | | 52.9 | 50.0 | 47.0 | 45.0 | 40.0 | 41.2 |
| Al₂O₃ | | 0.4 | 3.3 | 1.0 | 8.3 | 0.0 | 2.9 |
| B₂O₃ | | 0.0 | 0.0 | 0.0 | 0.0 | 0.0 | 0.0 |
| CaO | | 32.3 | 32.3 | 25.0 | 32.3 | 40.0 | 38.2 |
| ZnO | | 13.5 | 13.5 | 22.0 | 13.5 | 20.0 | 17.7 |
| MgO | | 0.0 | 0.0 | 0.0 | 0.0 | 0.0 | 0.0 |
| SrO | | 0.0 | 0.0 | 0.0 | 0.0 | 0.0 | 0.0 |
| BaO | | 0.9 | 0.9 | 5.0 | 0.9 | 0.0 | 0.0 |
| Total | | 100.0 | 100.0 | 100.0 | 100.0 | 100.0 | 100.0 |
| RO total | | 0.9 | 0.9 | 5.0 | 0.9 | 0.0 | 0.0 |
| Tg (° C.) | | 677 | 693 | 677.0 | 711 | 625 | 690 |
| Ts (° C.) | | 810 | 749 | 785 | 829 | — | 800 |
| Tx (° C.) | | 900 | 940 | 914 | 941 | 718 | 841 |
| ΔT = Tx − Ts | | 90 | 191 | 129 | 112 | — | 41 |
| D50 (μm) | | 6.2 | 4.1 | 4.9 | 4.7 | 5.0 | 4.6 |
| α (50° C. to 850° C.) | | 93 | 83 | 86 | 72 | 95 | 90 |
| (×10⁻⁷/° C.) | | | | | | | |
| Crystal | Ca₂ZnSi₂O₇ | ◯ | ◯ | ◯ | ◯ | ◯ | ◯ |
| phases | CaAl₂Si₂O₈ | — | — | — | ◯ | — | ◯ |
| | Others | SiO₂ | CaSiO₃ | — | — | — | — |

| | | | | | | |
|---|---|---|---|---|---|---|
| Sealability | Δ | ◯ | ◯ | ◯ | Δ | Δ |

TABLE 2

| | | | | | Example | Example | Example |
|---|---|---|---|---|---|---|---|
| Composition (mol. %) | | Example 7 | Example 8 | Example 9 | 10 | 11 | 12 |
| SiO₂ | | 41.6 | 42.9 | 45.0 | 47.0 | 47.5 | 48.2 |
| Al₂O₃ | | 4.2 | 7.1 | 8.3 | 17.7 | 19.1 | 20.7 |
| B₂O₃ | | 0.0 | 0.0 | 0.0 | 0.0 | 0.0 | 0.0 |
| CaO | | 37.5 | 35.7 | 33.2 | 29.4 | 28.6 | 27.6 |
| ZnO | | 16.7 | 14.3 | 13.5 | 5.9 | 4.8 | 3.5 |
| MgO | | 0.0 | 0.0 | 0.0 | 0.0 | 0.0 | 0.0 |
| SrO | | 0.0 | 0.0 | 0.0 | 0.0 | 0.0 | 0.0 |
| BaO | | 0.0 | 0.0 | 0.0 | 0.0 | 0.0 | 0.0 |
| Total | | 100.0 | 100.0 | 100.0 | 100.0 | 100.0 | 100.0 |
| RO total | | 0.0 | 0.0 | 0.0 | 0.0 | 0.0 | 0.0 |
| Tg (° C.) | | 695 | 704 | 711 | 764 | 771 | 794 |
| Ts (° C.) | | 806 | 825 | 826 | 898 | — | — |
| Tx (° C.) | | 864 | 917 | 932 | 951 | 943 | 944 |
| ΔT = Tx − Ts | | 58 | 92 | 106 | 53 | — | — |
| D50 (μm) | | 4.2 | 2.9 | 4.1 | 3.6 | 4.2 | 4.1 |
| α (50° C. to 850° C.) | | 83 | 82 | 68 | 52 | 59 | 53 |
| (×10⁻⁷/° C.) | | | | | | | |
| Crystal | Ca₂ZnSi₂O₇ | ◯ | ◯ | ◯ | ◯ | ◯ | ◯ |
| phases | CaAl₂Si₂O₈ | ◯ | ◯ | ◯ | ◯ | ◯ | ◯ |
| | Others | — | — | — | — | — | — |

| | | | | | | |
|---|---|---|---|---|---|---|
| Sealability | Δ | ◯ | ◯ | Δ | Δ | Δ |

TABLE 3

| Composition (mol · %) | | Example 13 | Example 14 | Example 15 |
|---|---|---|---|---|
| SiO₂ | | 42.1 | 40.0 | 37.9 |
| Al₂O₃ | | 10.6 | 10.0 | 9.4 |
| B₂O₃ | | 0.0 | 0.0 | 0.0 |
| CaO | | 31.7 | 30.0 | 28.3 |
| ZnO | | 10.6 | 10.0 | 9.4 |
| MgO | | 0.0 | 0.0 | 0.0 |
| SrO | | 0.0 | 0.0 | 0.0 |
| BaO | | 5.0 | 10.0 | 15.0 |
| Total | | 100.0 | 100.0 | 100.0 |
| RO total | | 5.0 | 10.0 | 15.0 |
| Tg (° C.) | | 723 | 733 | 725 |
| Ts (° C.) | | 857 | 857 | 851 |
| Tx (° C.) | | 968 | 982 | 1002 |
| ΔT = Tx − Ts | | 111 | 125 | 150 |
| D50 (μm) | | 3.5 | 3.3 | 2.8 |
| α (50° C. to 850° C.) | | 77 | 85 | 95 |
| (×10⁻⁷/° C.) | | | | |
| Crystal phases | Ca₂ZnSi₂O₇ | ◯ | ◯ | ◯ |
| | CaAl₂Si₂O₈ | ◯ | ◯ | ◯ |
| | Others | Ba_{0.8}Al_{1.6}Si_{2.4}O₈ | Ba_{0.8}Al_{1.6}Si_{2.4}O₈ | BaAl₂Si₂O₈, |
| | | | | Ba_{1.31}Ca_{0.69}SiO₄ |

| | | | |
|---|---|---|---|
| Sealability | ◯ | Δ | ◯ |

TABLE 4

| Composition (mol · %) | | Example 16 | Example 17 | Example 18 |
|---|---|---|---|---|
| SiO₂ | | 45.0 | 45.0 | 45.0 |
| Al₂O₃ | | 8.3 | 8.3 | 8.3 |
| B₂O₃ | | 0.0 | 0.0 | 0.0 |
| CaO | | 16.6 | 16.6 | 16.6 |
| ZnO | | 13.5 | 13.5 | 13.5 |
| MgO | | 0.0 | 0.0 | 16.6 |
| SrO | | 0.0 | 16.6 | 0.0 |
| BaO | | 16.6 | 0.0 | 0.0 |
| Total | | 100.0 | 100.0 | 100.0 |
| RO total | | 16.6 | 16.6 | 16.6 |
| Tg (° C.) | | 747 | 744 | 651 |
| Ts (° C.) | | 845 | 838 | 753 |
| Tx (° C.) | | 889 | 888 | 926 |
| ΔT = Tx − Ts | | 44 | 50 | 173 |
| D50 (μm) | | 3.2 | 3.4 | 5.1 |
| α (50° C. to 850° C.) | | 80 | 68 | 60 |
| (×10⁻⁷/° C.) | | | | |
| Crystal phases | Ca₂ZnSi₂O₇ | ◯ | ◯ | ◯ |
| | CaAl₂Si₂O₈ | — | — | ◯ |
| | Others | SiO₂, | SrAl₂Si₂O₈ | Ca₂Al₂O₅, MgSiO₃, |
| | | BaAl₂Si₂O₈, | | SiO₂, Ca₂SiO₄ |
| | | Ba_{0.8}Al_{1.6}Si_{2.4}O₈ | | |

| | | | |
|---|---|---|---|
| Sealability | Δ | Δ | ◯ |

TABLE 5

| Composition (mol · %) | | Example 19 | Example 20 | Example 21 | Example 22 |
|---|---|---|---|---|---|
| SiO₂ | | 45.5 | 44.2 | 43.3 | 41.6 |
| Al₂O₃ | | 7.8 | 7.5 | 7.4 | 6.9 |
| B₂O₃ | | 0.0 | 3.0 | 5.0 | 3.0 |
| CaO | | 32.3 | 31.4 | 30.7 | 34.6 |
| ZnO | | 13.5 | 13.1 | 12.8 | 13.9 |
| MgO | | 0.0 | 0.0 | 0.0 | 0.0 |
| SrO | | 0.0 | 0.0 | 0.0 | 0.0 |
| BaO | | 0.9 | 0.8 | 0.8 | 0.0 |
| Total | | 100.0 | 100.0 | 100.0 | 100.0 |
| RO total | | 0.9 | 0.8 | 0.8 | 0.0 |
| Tg (° C.) | | 710 | 669 | 659 | 673 |
| Ts (° C.) | | 827 | 800 | 788 | 792 |
| Tx (° C.) | | 977 | 969 | 961 | 943 |
| ΔT = Tx − Ts | | 150 | 170 | 172 | 152 |
| D50 (μm) | | 4.9 | 5.0 | 6.6 | 4.5 |
| α (50° C. to 850° C.) | | 71 | 79 | 81 | 82 |
| (×10⁻⁷/° C.) | | | | | |
| Crystal phases | Ca₂ZnSi₂O₇ | ◯ | ◯ | ◯ | ◯ |
| | CaAl₂Si₂O₈ | ◯ | ◯ | ◯ | ◯ |
| | Others | — | — | — | — |

| | | | | |
|---|---|---|---|---|
| Sealability | ◯ | ◯ | ◯ | ◯ |

TABLE 6

| Composition (mol · %) | | Example 23 | Example 24 | Example 25 |
|---|---|---|---|---|
| SiO₂ | | 44.5 | 43.1 | 41.7 |
| Al₂O₃ | | 11.1 | 10.8 | 10.5 |
| B₂O₃ | | 0.0 | 3.0 | 6.0 |
| CaO | | 33.3 | 32.3 | 31.3 |
| ZnO | | 11.1 | 10.8 | 10.5 |
| MgO | | 0.0 | 0.0 | 0.0 |
| SrO | | 0.0 | 0.0 | 0.0 |
| BaO | | 0.0 | 0.0 | 0.0 |
| Total | | 100.0 | 100.0 | 100.0 |
| RO total | | 0.0 | 0.0 | 0.0 |
| Tg (° C.) | | 721 | 691 | 688 |
| Ts (° C.) | | 849 | 820 | 795 |
| Tx (° C.) | | 946 | 951 | 923 |
| ΔT = Tx − Ts | | 97 | 131 | 128 |
| D50 (μm) | | 4.5 | 4.7 | 4.3 |
| α (50° C. to 850° C.) | | 67 | 74 | 73 |
| (×10⁻⁷/° C.) | | | | |
| Crystal phases | Ca₂ZnSi₂O₇ | ◯ | ◯ | ◯ |
| | CaAl₂Si₂O₈ | ◯ | ◯ | ◯ |
| | Others | — | CaAl₂SiO₇ | CaAl₂SiO₇ |

| | | | |
|---|---|---|---|
| Sealability | ◯ | ◯ | ◯ |

TABLE 7

| Composition (mol · %) | Example 26 | Example 27 |
|---|---|---|
| SiO₂ | 44.7 | 42.7 |
| Al₂O₃ | 16.8 | 16.1 |
| B₂O₃ | 5.0 | 9.0 |
| CaO | 27.9 | 26.8 |
| ZnO | 5.6 | 5.4 |
| MgO | 0.0 | 0.0 |
| SrO | 0.0 | 0.0 |
| BaO | 0.0 | 0.0 |
| Total | 100.0 | 100.0 |
| RO total | 0.0 | 0.0 |
| Tg (° C.) | 711 | 685 |
| Ts (° C.) | 855 | 824 |
| Tx (° C.) | 909 | 921 |
| ΔT = Tx − Ts | 54 | 97 |
| D50 (μm) | 4.3 | 4.7 |
| α (50° C. to 850° C.) | 60 | 63 |
| (×10⁻⁷/° C.) | | |

| | | | |
|---|---|---|---|
| Crystal phases | Ca₂ZnSi₂O₇ | ◯ | ◯ |
| | CaAl₂Si₂O₈ | ◯ | ◯ |
| | Others | — | — |

| | | |
|---|---|---|
| Sealability | Δ | Δ |

TABLE 8

| | | Comparative | Comparative | Comparative | Comparative |
|---|---|---|---|---|---|
| Composition (mol · %) | | Example 1 | Example 2 | Example 3 | Example 4 |
| SiO₂ | | 57.4 | 51.5 | 45.0 | 45.0 |
| Al₂O₃ | | 0.4 | 1.0 | 8.3 | 8.3 |
| B₂O₃ | | 0.0 | 0.0 | 0.0 | 0.0 |
| CaO | | 28.0 | 13.1 | 0.0 | 0.0 |
| ZnO | | 12.0 | 16.7 | 13.5 | 13.5 |
| MgO | | 0.0 | 7.1 | 0.0 | 33.2 |
| SrO | | 0.0 | 0.0 | 0.0 | 0.0 |
| BaO | | 2.2 | 10.6 | 33.2 | 0.0 |
| Total | | 100.0 | 100.0 | 100.0 | 100.0 |
| RO total | | 2.2 | 17.5 | 33.2 | 33.2 |
| Tg (° C.) | | 692 | 599 | 740 | 727 |
| Ts (° C.) | | 750 | — | — | 847 |
| Tx (° C.) | | 940 | 870 | 844 | 912 |
| ΔT = Tx − Ts | | 190 | — | — | 65 |
| D50 (μm) | | 6.0 | 4.0 | 3.1 | 5.0 |
| α (50° C. | | | | | |
| to 850° C.) | | 106 | 102 | Not | 101 |
| (×10⁻⁷/° C.) | | | | measurable | |
| Crystal phases | Ca₂ZnSi₂O₇ | ◯ | — | — | — |
| | CaAl₂Si₂O₈ | — | — | — | — |
| | Others | CaSiO₃, SiO₂ | CaMgSi₂O₆, | Ba₂ZnSi₂O₇, | ZnAl₂O₄, |
| | | | Ba₂ZnSi₂O₇ | BaAl₂Si₂O₈ | Mg₂SiO₄, |
| | | | | | MgSiO₃, |
| | | | | | Zn₂SiO₄ |

| | | | | |
|---|---|---|---|---|
| Sealability | ◯ | X | Δ | Δ |

As is clear from the results shown in Tables 1 to 7, Ca₂ZnSi₂O₇ crystal phases were observed in the glass compositions of Examples, and it is understood that excellent heat resistance can be expected. In addition, because sealability was also good, it is understood that excellent performance such as fluidity can be achieved when using the glass composition of the present invention.

In contrast, Ca₂ZnSi₂O₇ crystal phases were not observed in Comparative Examples 2 to 4, as shown in Table 8, and because MgO—CaO—SiO₂-based crystals or BaO—CaO—SiO₂-based crystals were precipitated, it is understood that heat resistance is insufficient or the coefficient of thermal expansion is too high. In addition, Ca₂ZnSi₂O₇ crystal phases were observed in Comparative Example 1, but because the coefficient of thermal expansion in particular was too high, it is understood that Comparative Example 1 is not suitable for sealing.

### INDUSTRIAL APPLICABILITY

By being applied to surfaces of metals and semiconductors and fired at a temperature of, for instance, 1100° C., the sealing glass composition of the present invention can achieve advantageous sealing between members. The sealing agent of the present invention is particularly useful as a sealing material for sealing temperature sensors used under conditions of high temperature, such as 1100° C. or higher, for example.

1. A sealing glass composition for producing a glass ceramic sealant containing at least CaO—ZnO—SiO₂-based crystals,
the sealing glass composition comprising at least the following components:
1) 35 to 55 mol. % of SiO₂,
2) 15 to 45 mol. % of CaO,
3) 1 to 25 mol. % of ZnO,
4) 0 to 25 mol. % of Al₂O₃, and
5) a total of 0 to 20 mol. % of RO where R represents at least one of Mg, Sr and Ba.

2. The sealing glass composition according to claim 1, wherein the components are contained at following quantities:
1) 41 to 55 mol. % of SiO₂,
2) 20 to 39 mol. % of CaO,
3) 3 to 19 mol. % of ZnO,
4) 0.1 to 21 mol. % of Al₂O₃, and
5) a total of 0 to 20 mol. % of RO where R represents at least one of Mg, Sr and Ba.

3. The sealing glass composition according to claim 1, wherein the components are contained at following quantities:
1) 42 to 52 mol. % of SiO₂,
2) 29 to 36 mol. % of CaO,
3) 5 to 16 mol. % of ZnO,
4) 2 to 19 mol. % of Al₂O₃, and
5) a total of 0 to 20 mol. % of RO where R represents at least one of Mg, Sr and Ba.

4. The sealing glass composition according to claim 1, comprising 0 to 5 mol. % of MgO, 0 to 20 mol. % of SrO and 0 to 5 mol. % of BaO as the RO component.

5. The sealing glass composition according to claim 1, further comprising 1 to 9 mol. % of B₂O₃.

6. A CaO—ZnO—SiO₂-based glass ceramic sealant,
(1) comprising at least following components:
1) 35 to 55 mol. % of SiO₂,
2) 15 to 45 mol. % of CaO,
3) 1 to 25 mol. % of ZnO,
4) 0 to 25 mol. % of Al₂O₃, and
5) a total of 0 to 20 mol. % of RO where R represents at least one of Mg, Sr and Ba, and
(2) containing at least Ca₂ZnSi₂O₇ crystals as CaO—ZnO—SiO₂-based crystals.

7. The CaO—ZnO—SiO₂-based glass ceramic sealant according to claim 6, further comprising 1 to 9 mol. % of B₂O₃.

8. The CaO—ZnO—SiO₂-based glass ceramic sealant according to claim 6, wherein the coefficient of thermal expansion within a temperature of 50° C. to 850° C. is 50 to 95×10⁻⁷/° C.

9. An electronic device comprising an electronic component sealed with the CaO—ZnO—SiO₂-based glass ceramic sealant according to claim 6.

10. A method for producing a CaO—ZnO—SiO₂-based glass ceramic sealant,
the method comprising a step of heat treating the sealing glass composition according to claim 1 at a temperature of 1,000° C. to 1,300° C.
